(19) United States
(12) Patent Application Publication
(10) Pub. No.: US 2004/0090667 A1
(43) Pub. Date: May 13, 2004

(54) Microscopy system

(75) Inventors: Hartmut Gartner, Oberkochen (DE); Ulrich Nagele, Bartholoma (DE); Andreas Obrebski, Dusseldorf (DE); Gerhard Gaida, Aalen (DE)

Correspondence Address: Steven M. duBois, Potomac Patent Group, PLLC, PO Box 855, McLean, VA, 22101-0855, US

(73) Assignee: Carl-Zeiss-Stiftung trading as Carl Zeiss, Heidenheim (DE)

(21) Appl. No.: 10/393,358

(22) Filed: Mar. 21, 2003

(30) Foreign Application Priority Data
Mar. 22, 2002 (DE) 102 12 906.1

(51) Int. Cl. G02B 21/00

(52) U.S. Cl. 359/368

(57) ABSTRACT

A microscopy system for imaging an object is proposed, comprising: microscopy optics including an objective system (3) with an object plane (13) whose working distance (A) from the objective system is adjustable, and a first projection system for projecting at least one shaped analysis light beam (33, 34) onto the object and for generating at least one light spot (39) on the same. The analysis light beam (33, 34) is shaped such that a shape of a cross-section of the analysis light beam (33, 34) changes in beam direction.

The microscopy system may further comprise: a position-sensitive radiation detector (51), an imaging optics for imaging the at least one light spot (39) generated on the object on the position-sensitive radiation detector (51), and a circuit (61) for evaluating the detected light spot and for supplying a focusing signal on the basis of a shape of the light spot (39).

The present invention relates to a microscopy system for imaging an object, the microscopy system comprising a microscopy optics whose working distance is variable.

A distance of an object plane from the microscopy optics is referred to as working distance. The object plane as such is defined as a spatial region which is substantially sharply imaged by the microscopy optics. A surface of the object disposed in the object plane is thus substantially sharply imaged for the observation by a user, for example, through oculars of the microscopy optics or, for example, for recordal by a camera. If the distance between the object and the microscopy optics is already adjusted or predetermined and no sharp image of the object is produced thereby, the user will vary the working distance of the microscopy optics until a sharp image of the object is obtained.

To this end, conventional microscopy systems comprise manually or power operated drives to “focus” the microscopy optics to the object. With low-contrast objects it is often difficult to find the optimum focusing adjustment. Moreover, finding the optimum focusing state requires concentration and manipulation on the part of the user which distracts him from his actual observation task.

From U.S. Pat. No. 4,516,840 a microscopy system is known which assists the user in determining the focusing state of a microscopy optics. The microscopy system comprises a projector for projecting a light spot shaped by a contoured first aperture mask and having a shape corresponding to the contour of the mask onto the object. An imaging optics images the light spot on a detector, a second aperture mask which has a contour corresponding to the first mask being positioned in the beam path in front of the detector. The two masks are aligned relative to an optical axis of the microscopy optics such that, when the object is positioned in the object plane, a detector signal is generated which is indicative of the focusing state. This conventional system is, however, not sensitive enough to detect slight defocusings, and the user must nevertheless change the adjustment of the microscopy optics himself in order to optimize the focusing state.

It is an object of the present invention to provide a microscopy system with variable working distance, wherein a focusing state is recognizable for the user with more ease.

Moreover, it is an object of the present invention to provide a microscopy system wherein the adjustment of a substantially optimum focusing state is achievable for the user with more ease.

To this end, the invention proposes a microscopy system for imaging an object comprising a microscopy optics with an objective system. The microscopy optics images the object substantially sharply if it is disposed approximately in an object plane of the microscopy optics. In order to take account of variable distances between the object and the objective system, a working distance of the microscopy optics, that is, the distance between the object plane and the objective system, is adjustable. The adjustment of the working distance is performed, for example, either by manual operation by the user himself or automated, for example, by means of a drive which displaces two components of the microscopy optics relative to one another or by other techniques.

Moreover, a projection system is provided for projecting at least one shaped analysis light beam through the objective system onto the object and for generating at least one light spot on the same. A shape of the light spot generated on the object is determined by the analysis light beam.

According to the invention, the analysis light beam is shaped such that a shape of a cross-section of the analysis light beam changes in beam direction.

As the light spot has substantially the same shape as the cross-section of the analysis light beam in a cross-sectional plane which coincides with the object surface, the user can recognize, on the basis of the shape of the light spot, whether the object surface is disposed substantially in the object plane. The user is thus able to conclude from the observation of the light spot on the object generated by the analysis light beam to the focusing state of the microscopy system.

In the present case, the “shape” of the cross-section is not equivalent to the size thereof. A size of a spot or pattern can be changed, for example, by a simple isotropic scaling without changing the shape thereof. Other than the size, the shape of the light spot is characterized by at least two geometric parameters, for example, by a minimal diameter of the light spot and a maximal diameter thereof. Other kinds of parameters are also conceivable in this respect. In this case, the two parameters should vary in beam direction independently of each other so that it can be concluded from a comparison of the same to the focusing state of the objective system. If the minimal diameter and the maximal diameter of the light spot are selected as parameters, for example, a ratio of the minimal diameter to the maximal diameter changes in beam direction.

A relatively simple distinguishability between a largely optimum focusing state and a less optimum focusing state is given if the cross-section of the analysis light beam has a substantially stout shape in the object plane, and the shape of the cross-section increasingly elongates with increasing distance from the object plane.

With a view to such a distinguishability, it is also advantageous for the shape of the cross-section to be coherent in the object plane and to disintegrate into partial components outside of the object plane.

In order to automatically adjust the focusing state, the microscopy system furthermore comprises a position-sensitive radiation detector for supplying data which are representative of a position dependency of a radiation intensity impinging on the radiation detector. Moreover, an imaging optics is provided to image the at least one light spot generated on the object on the radiation detector. Moreover, a circuit is provided for evaluating the data delivered by the detector and for supplying a focusing signal on the basis of a shape of the at least one light spot imaged on the radiation detector such that the focusing signal is representative of a distance between the object and the object plane. Here, the evaluation of the shape can include the determination of a contour of the light spot, with an intensity threshold value being determined, for example, in order to distinguish between a location within the light spot and a location outside of the light spot. Moreover, it is possible to incorporate an intensity distribution within the light spot into the evaluation of the shape.

In this connection, too, the term “shape” differs, for example, from the term size, and the explanations given above in respect of the shape of the beam cross-section are applicable here as well.

By evaluating the shape of the at least one light spot imaged on the detector, it is possible to automatically detect the focusing state of the microscopy optics and to output the focusing signal, for example, to suitable actuators which serve to change the working distance of the microscopy optics. Such actuators can comprise a drive for displacing two components of the microscopy optics, to which drive the focusing signal is supplied such that it displaces the two components of the microscopy optics relative to each other such that the working distance of the microscopy optics corresponds to the distance of the object from the microscopy optics and thus the microscopy optics is focused to the object. As a result, the user is relieved from the task of adjusting the optimum focusing setting. Moreover, it is possible to select the light of the analysis light beam such that the user perceives the at least one light spot on the object and, on the basis of the shape thereof, also immediately recognizes the focusing state of the microscopy optics. The user can then shut off the drive for displacing the two components of the microscopy optics and perform the adjustment of the focusing state himself.

Moreover, it is possible to provide a display for displaying the focusing signal for the user. Such a display can, for example, be fed into the beam path of the microscope. As a result, the user has the possibility, even if the microscopy system includes no automated drive, to adjust the microscopy optics, for example, by hand such that the focusing state is substantially optimal.

In the microscopy system use is made of the circumstance that, due to the analysis light beam being projected through the objective system, the shape of the at least one light spot projected onto the object changes when the working distance of the microscopy optics is changed. If, in a substantially optimum focusing state, the shape of the at least one light spot is known as a reference shape, the drive can be actuated until the shape of the light spot detected by the detector corresponds to the reference shape. As a result, optimum focusing is achieved.

In this respect, it is possible that the imaging optics for imaging the at least one light spot on the position-sensitive radiation detector is an optical system which is separate from the objective system of the microscopy optics.

Preferably, the objective system, however, forms part of the imaging optics so that a beam path between the object and the radiation detector extends through the objective system. As a result, the sensitivity of the detection of the focusing state can be increased since also the imaging characteristic changes between the light spot on the object and the light spot imaged on the radiation detector as the working distance changes and, accordingly, the shape of the at least one light spot imaged on the detector can be different from the at least one light spot originally formed on the object. Such a difference in the shape of the imaged light spot can also be utilized for determining the substantially optimum focusing setting. In particular, an optimum focusing setting can be determined if the shape imaged on the detector is equal to the shape of the light spot formed on the object.

Preferably, the projection system projects two light beams which traverse the objective system spaced apart from each other and intersect each other in the object plane. If the object is then closer to the objective system or further away from the same than it corresponds to the adjusted working distance of the microscopy optics, two separate light spots are generated on the object. Accordingly, the radiation detector will detect a position-dependent radiation intensity caused by the light spots, the shapes of which comprise two spatially separated partial components. If the object is disposed in the object plane, the two projected beams overlap there and generate a single light spot. The radiation detector then detects a radiation intensity caused by the light spot which has a spatially coherent shape. The controller then delivers the focusing signal, for example, to the drive such that this spatially coherent shape is provided. If the microscopy system is only slightly defocused, the two light beams projected onto the object will not yet generate two separate light spots, but a single elongated light spot. In case of an optimum focusing, this light spot, however, will have a reduced diameter so that the controller preferably continues to supply the focusing signal such that the shape of the light spot imaged on the detector has a minimal diameter.

The position-sensitive radiation detector may be a two-dimensional spatially resolving radiation detector such as a CCD detector. In order to provide an inexpensive configuration and a simple evaluation of the data delivered by the detector, it is, however, advantageous and sufficient to use a line detector which is oriented such that at each defocused setting of the microscopy optics both light spots generated are imaged on the line detector.

It is provided for that, apart from the at least one analysis light beam, at least one further auxiliary light beam is projected through the objective system onto the object, by means of which the object can be scanned, for example, or operations, such as ablation, can be performed on the object. In this respect, the color of the auxiliary light beam is preferably different from the color of the analysis light beam, and the imaging optics comprises a color filter which is impermeable for the color of the auxiliary light beam in order for the adjustment of the focusing to be not disturbed by the auxiliary light beam.

It is likewise preferred for the projection system to project a single light beam in the direction of the object such that this beam is substantially focused in the object plane and thus has a smaller diameter there than outside of the object plane. The light spot imaged on the radiation detector will then also have a minimal diameter when the object is positioned in the object plane. Accordingly, the controller preferably supplies the focusing signal such that it is representative of a substantially optimum focusing if the shape of the imaged light spot has a minimal diameter.

It is equally preferred for the imaging optics to comprise a plurality of lenses juxtaposed in beam cross-section in order to generate several juxtaposed images of the light spot on the radiation detector. Each lens of the plurality of lenses has a different focal length, or the lenses are spaced apart from the radiation detector at different distances. Depending on the focusing state, the several images then have different sizes. If the sizes of the individual light spots, that is, their shapes, are known for the optimum focusing state, the controller supplies the focusing signal such that it is possible to obtain this reference shape of the individual light spots on the basis of the focusing signal.

This configuration has the advantage that the controller can easily discriminate whether the working distance is adjusted too large or too small.

Moreover, it is preferred for the projection system to project an astigmatically formed light beam which is differently convergent in two directions extending orthogonally to each other and to the direction of the analysis light beam. In this case, the analysis light beam is preferably shaped such that the light spot generated on the object is elongated in a first direction if the object is disposed closer to the objective system than it corresponds to the working distance, and the light spot is elongated in a second direction extending orthogonally thereto if the object is disposed further away from the objective system than it corresponds to the working distance. The controller then supplies the focusing signal such that it indicates a substantially optimum focusing if the light spot imaged on the radiation detector has a shape which is neither elongated in the first direction nor in the second direction.

To this end, the radiation detector can be a two-dimensionally position-sensitive radiation detector. However, it is preferred and sufficient to provide a four-quadrant photodetector for evaluating the shape of the light spot imaged on the detector.

Preferably, the projection system comprises a light source for generating the at least one projection beam, which light source is intensity-modulated or/and wavelength-modulated. This is particularly advantageous if the light spot generated on the object is only insignificantly brighter than the object outside of the light spot. The controller can then use such data for the evaluation which exhibit an intensity change or wavelength change modulated synchronously to the light source.

In particular, this configuration is also advantageous if a light spot projected onto the object with a high radiation intensity is perceived as disturbing by the user. It is then possible to reduce the intensity of the analysis light beam to such an extent that the light spot is substantially no longer perceived by the user.

Preferably, there is also provided a beam shutter to interrupt the analysis light beam so that the user can switch off this beam if he feels disturbed by the same, for example.

Embodiments of the invention are described hereinafter with reference to the drawings, wherein

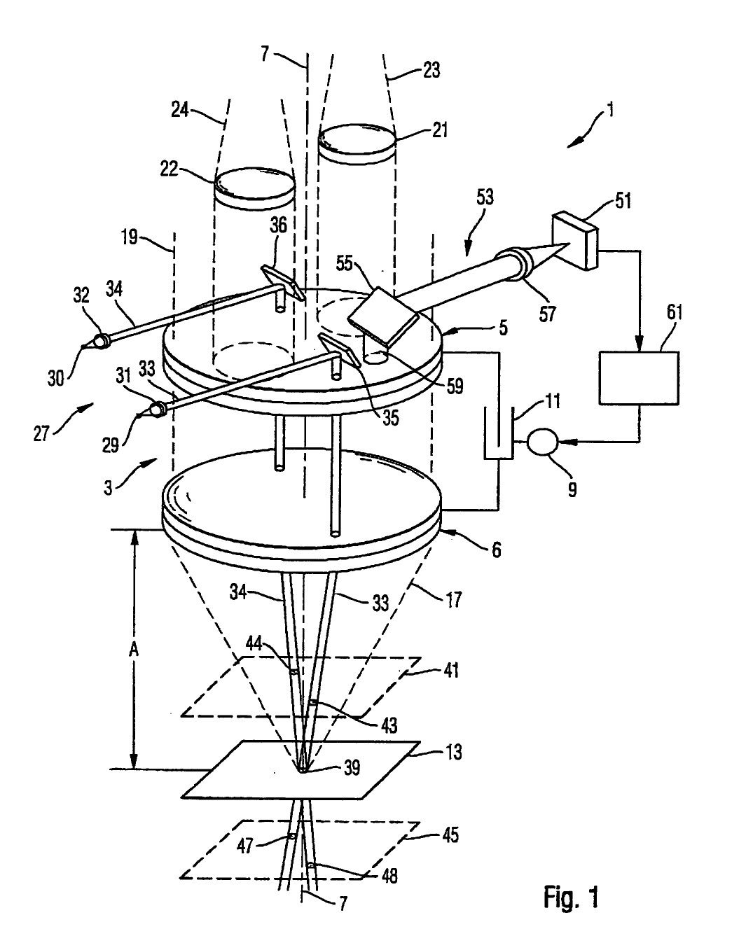

FIG. 1 is a partial view of a microscopy system according to a first embodiment of the invention,

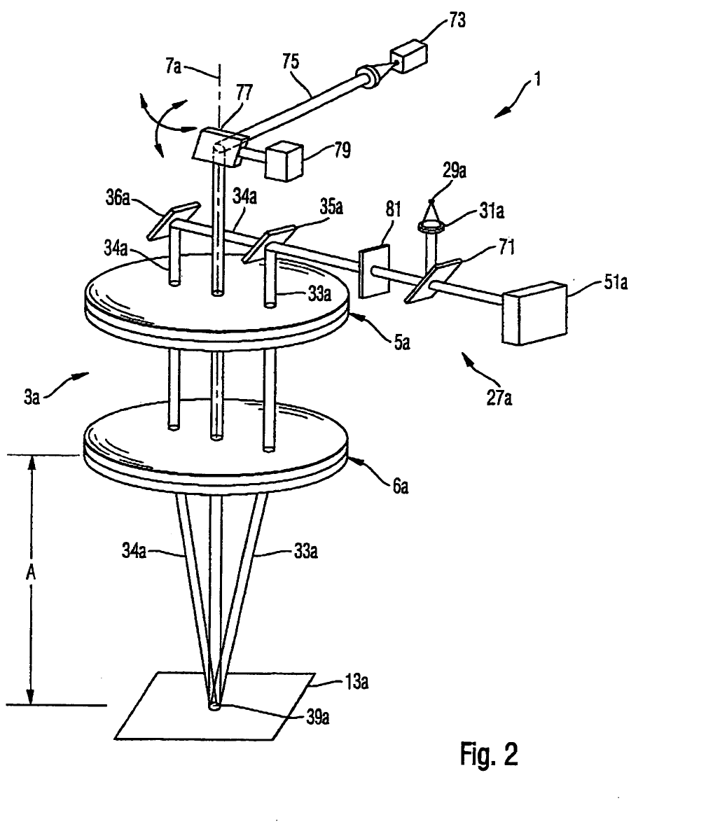

FIG. 2 is a partial view of a microscopy system according to a second embodiment of the invention,

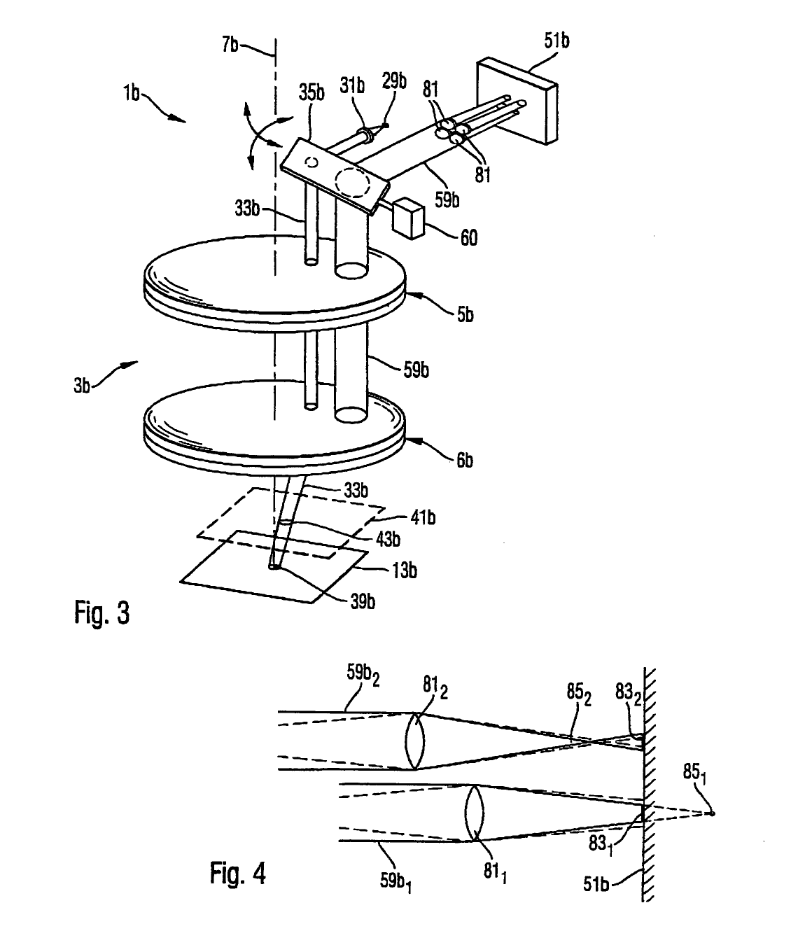

FIG. 3 is a partial view of a microscopy system according to a third embodiment of the invention,

FIG. 4 is a detailed view of FIG. 3,

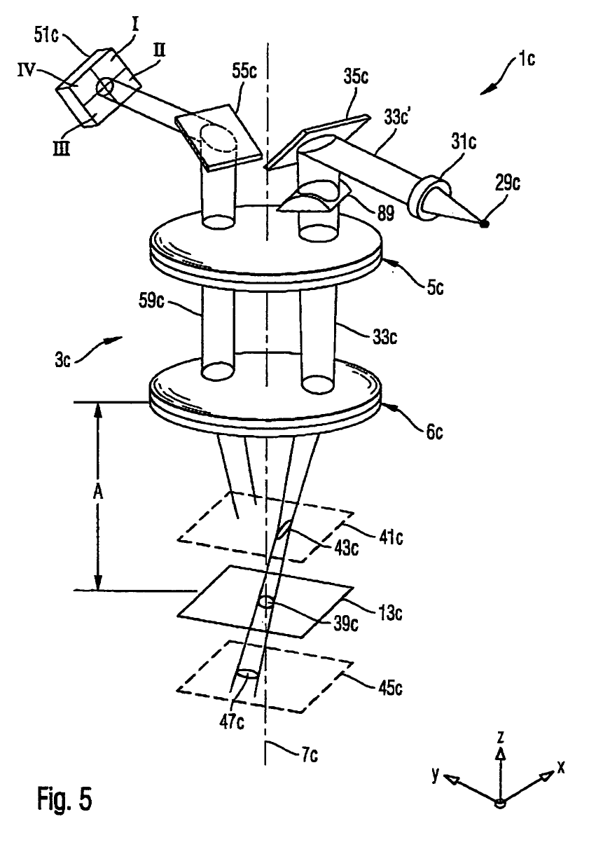

FIG. 5 is a partial view of a fourth embodiment of the invention,

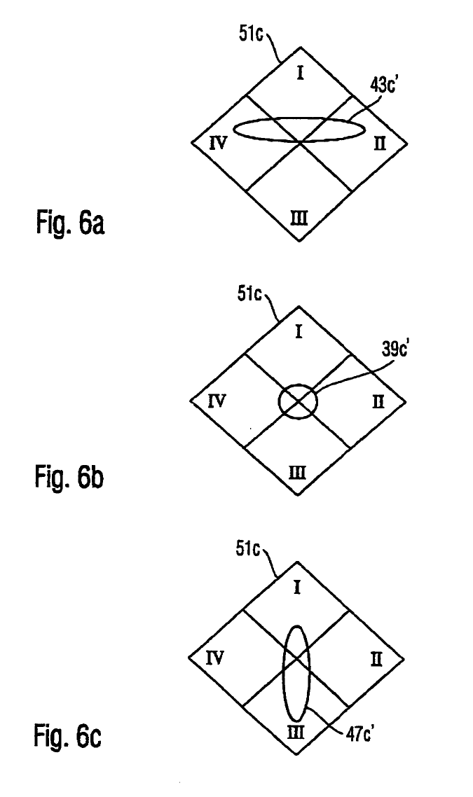

FIG. 6 shows representations of the shapes of light spots imaged on a radiation detector of the microscopy system shown in FIG. 5,

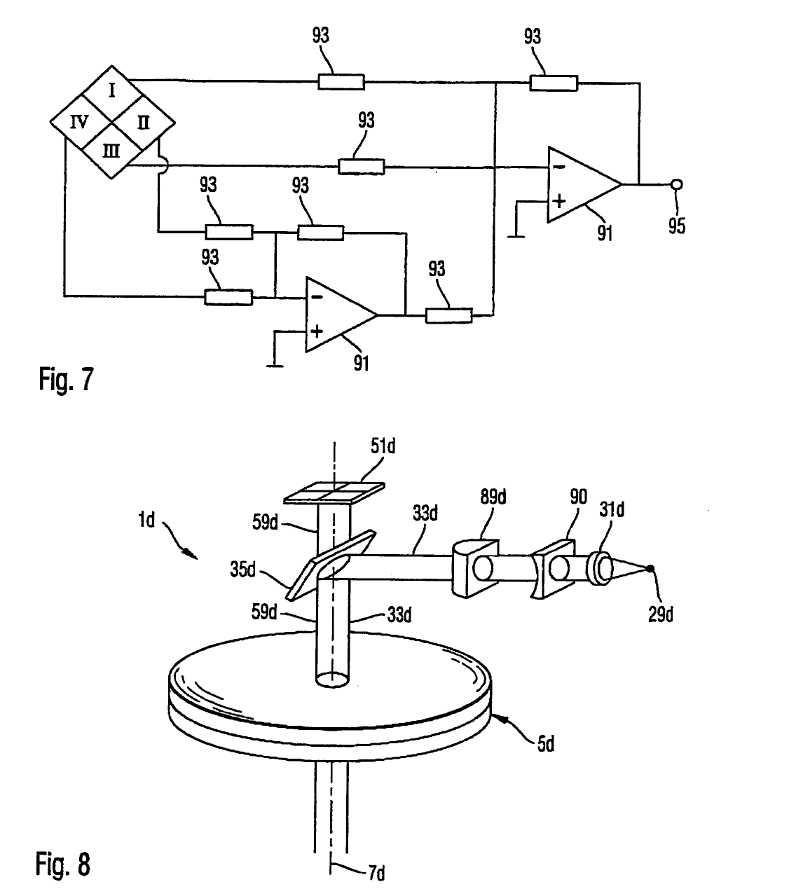

FIG. 7 shows a controller for the evaluation of the data of the radiation detector shown in FIG. 6,

FIG. 8 is a partial view of a microscopy system according to a fifth embodiment, and

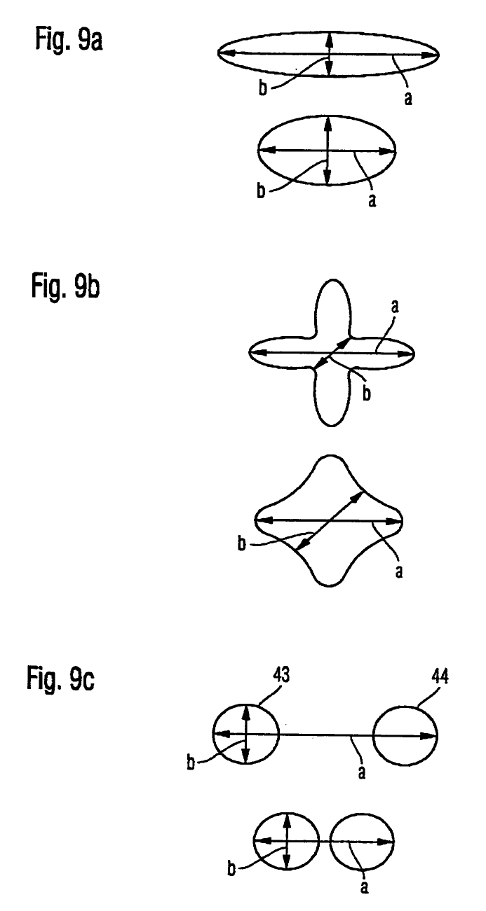

FIG. 9 shows different shapes of the cross-section of the analysis light beam.

A stereomicroscope 1 shown in FIG. 1 comprises an objective system 3 with two lens groups 5,6, each of which comprises two cemented lenses. The two lens groups 5 and 6 have a common optical axis 7 and are disposed along this axis spaced apart from each other. An actuating mechanism 11 driven by an electromotor 9 is provided to vary the distance between the two lens groups 5 and 6. In the position assumed by the two lens groups 5 and 6 relative to each other as shown in FIG. 1, an object plane 13 of the objective system 3 is spaced apart from the lens group 6 at a distance A. By varying the distance between the two lens groups 5, 6, the distance A of the object plane 13 from the lens group 6 is variable.

If an object is disposed in the object plane 13, a beam bundle 17 emanating from the object into a solid angle region is imaged to infinity by the objective system 3, as a result of which the beam bundle 17 emanating from the object is transformed into a parallel beam bundle 19.

Above the lens group 5, there are juxtaposed two lenses 21 and 22 in the parallel beam bundle 19. The lenses 21, 22 are front lenses of a zoom system, not shown in further detail in FIG. 1, of the microscopy system. The lenses 21, 22 feed two partial beam bundles 23, 24 out of the parallel beam bundle 19 which are respectively supplied to the left and right eyes of the user by means of oculars, likewise not shown in FIG. 1, so that the user views a stereoscopic image of the object disposed in the object plane 13.

The object is perceived by the user as sharply imaged if it is positioned in the object plane 13. If the object is spaced apart from the lens group 6 at a smaller or larger distance than it corresponds to the currently adjusted working distance A of the microscope 1, the user perceives unsharp images of the object. The motor 9 must then be operated in order to change the distance between the lens groups 5, 6 via the actuating mechanism 11 such that the working distance A is either decreased or increased.

In order to automate the adjustment of the working distance A to the distance of the object from the lens group 6, the stereomicroscope 1 comprises an autofocusing device. It includes a projection system 27 comprised of two laser diodes 29, 30 disposed spaced apart form each other, the emitted radiation of which is shaped by two collimator lenses 31, 32 to two parallel analysis light beams 33, 34. They respectively impinge on two deflection mirrors 35, 36 disposed above the lens group 5 for deflecting the analysis light beams 33, 34 such that they enter the lens group 5 from above parallel to the optical axis 7. The analysis light beams 33 and 34 traverse the lower lens group 6 and thereafter converge towards each other such that they overlap in the object plane 13. If the object is disposed in the object plane 13, the analysis light beams 33, 34 illuminate there a light spot 39 of circular shape.

If the object is disposed closer to the lens group 6 than it corresponds to the working distance A, as it is intimated in FIG. 1 by the plane 41, the analysis light beams 33, 34 generate two light spots 43 and 44 on the object which are spatially separated from each other. If the object is spaced apart from the lens group 6 further than it corresponds to the working distance A, as it is intimated in FIG. 1 by the plane 45, the analysis light beams 33, 34 likewise generate two light spots 47 and 48 on the object which are spatially spaced apart from each other.

The autofocusing system further comprises a position-sensitive beam detector 51 in the form of a camera chip, and an imaging optics 53 which is formed of the lens groups 5 and 6, the objective system 3, a deflection mirror 55 and a lens group 57 in order to image a partial beam bundle 59 fed out of the parallel beam bundle 19 on the camera chip 51. Accordingly, an image of the light spots generated by the analysis light beams 33, 34 on the object is also produced on the camera chip 51.

The autofocusing system further comprises a controller 61 for evaluating the data delivered by the camera 51 and for supplying, dependent upon this evaluation, a positioning signal to the motor 9. The controller 61 determines the geometric shape of the light spots imaged on the camera chip 51 and provides a control loop whose aim it is to adjust the shape of the imaged light spots such that it is a coherent shape, that is, that the shape does not disintegrate into spatially separated components. If this control aim is achieved, the working distance A is adjusted such that it corresponds to the distance of the object from the lens group 6 and the user thus obtains a correctly focused image of the object.

The laser diodes 29, 30 emit a time-modulated light intensity such that the brightness of the light spots generated on the object is time-modulated as well. The controller 61 filters the data of the camera chip 51 according to a lock-in method in order to thus increase a contrast of the light intensity generated by the light spots on the camera chip.

The camera 51 can further be used to produce images of the object as a whole and to record these images, for example, for documentation purposes.

Variants of the stereomicroscope shown in FIG. 1 will now be described hereinafter. Components which correspond to each other in structure and function are designated by the same reference numbers as in FIG. 1, however, for the purposes of distinction, supplemented by an additional letter. For the purpose of illustration, reference is taken to the entire above description.

A stereomicroscope 1a partially shown in FIG. 2 again comprises an objective system 3a with two lens groups 5a and 6a. For reasons of clarity, components which do not belong to an autofocusing system, such as a positioning mechanism for varying the working distance A or lenses of a zoom system etc., are not shown in FIG. 2. The autofocusing system again comprises a projection system 27a for projecting two analysis light beams 33a, 34a which overlap in an object plane 13a to form a coinciding light spot 39a.

The projection system 27a comprises a single light source 29a whose light is shaped by a collimation lens 31a to a parallel beam. This beam is reflected at a splitting mirror 71 towards an optical axis 7a and split at a further splitting mirror 35a into the one analysis light beam 33a and into the other analysis light beam 34a. The latter is reflected at a further mirror 36a such that it enters the lens group 5a parallel to the analysis light beam and also parallel to the optical axis 7a.

A laser 73 is provided to generate a processing light beam 75 which is directed, via a deflection mirror 77 disposed on the optical axis 7a, to the lens group 5a. The deflection mirror 77 is pivotable in two spatial directions via a control drive 79. In the home position of the deflection mirror 77, the processing light beam 75 is directed parallel to the optical axis and focused in the object plane 13a in order perform material processing on an object, for example, by laser ablation. By operating the actuating drive 79, the deflection mirror 77 is pivotable such that the processing can be carried out at arbitrary locations of the object.

In order to prevent the autofocusing system 27a from being disturbed by the processing laser beam 75, the processing light beam 75 and the analysis light beams 33a, 34a are of different colors.

The light spots generated on the object by the analysis light beams 33a, 34a are imaged on the camera 51a, the imaging system provided for this purpose comprising the lens groups 5a and 6a as well as the deflection mirrors 35a and 36a.

The light received by the camera 51a from the object extends opposite to the beam path along which the analysis light beams 33a, 34a are projected onto the object. However, this light traverses the splitting mirror straightly in order to impinge on the camera 51a.

In the beam path in front of the camera 51a, there is provided an appropriate filter 81 so that light of the processing laser 73 does not reach camera 51a.

A stereomicroscope 1b shown in FIG. 3 differs from the stereomicroscopes shown in FIGS. 1 and 2 substantially in that merely one single analysis light beam 33b is projected onto the object. This light beam generates a light spot 39b on the object positioned in an object plane 13b, and a light spot 43b on an object positioned in a plane 41b outside of the object plane 13b. As the analysis light beam 33b is convergent between a front lens group 6b of an objective 3b, the shapes of the light spots 39b and 43b differ from each other in size at least slightly. This difference in the shapes of the light spots 39b and 43b can well be utilized to control an autofocusing system. However, the stereomicroscope 1b comprises a group of four lenses 81 for imaging the object on a camera 51b, said lenses being juxtaposed in beam direction in a beam path of an imaging system in front of the camera 51b. The lenses 81 have each a different focal length. When a parallel beam bundle 59b impinges on the four lenses, each lens 81 produces an image of the light spot 39b on the chip of the camera 51b, the four resulting images having different diameters.

As an alternative to the four lenses 81 of different focal lengths being juxtaposed, it is also possible to position lenses 81 of equal focal lengths spaced apart from the camera chip 51b at different distances. This is shown in FIG. 4 in enlarged view. In this Figure, a lens 81₁ feeds a partial beam bundle 59b₁ out of the parallel beam bundle 59b and focuses it such that a focus 85₁ lies behind the camera chip 51b. The other lens 812 spaced apart from the camera chip 51b at a larger distance focuses a partial beam bundle 59b₂ such that a focus 85₂ is produced between the lens 81₂ and the camera chip 51b. The distances of the lenses 81₁, 81₂ from the camera chip 51b are dimensioned such that the images 83₁ and 83₂ of the light spots 39b are of equal diameter.

If, however, the object is not positioned in the object plane 13b, the objective system 3b does not image the object to infinity, and the beam bundle emitted by the objective system 3b is correspondingly a divergent or convergent beam bundle. The case of the divergent beam bundle emanating from the objective system 3b is shown in FIG. 4 in dashed outline. As compared to the case of the parallel partial beam bundles 59b₁ and 59b₂, the focuses 85₁ and 85₂ shift away from the lenses 81₁ and 81₂, as a result of which the image 83₁ of the light spot 39b increases in size and the image 83₂ of the light spot 39b decreases in size accordingly. As a result, the shape of the image of the light spot generated on the object by the analysis light beam 33b changes, which change can be analyzed by a controller, not shown in FIGS. 3 and 4, in order to control an actuating drive of the autofocusing system.

FIG. 3 further shows a deflection mirror 35b for deflecting the analysis beam which at first extends transversely to the optical axis 7b approximately parallel to the optical axis and for further deflecting the beam 59b towards the detector 51b. Moreover, an actuator 60 is provided to pivot the mirror 35b into two directions extending orthogonally to each other in order select in the field of view of the microscopy system the location where the light spot 39b is formed on the object or in the object plane. Accordingly, the light spot can be displaced to a location selectable by the user where it does substantially not disturb an observation to be performed. As the controller, not shown in FIG. 3, evaluates the shape of the image of the light spot 39b on the detector 51b and not the distance of the spot 39b from the optical axis, the examination of the light spot is effected translationally invariant, so to speak, in the field of view of the microscopy system.

In this respect, it is possible to use a deflection mirror for the analysis light beam which is provided separately from the deflection mirror which deflects the beam 59b towards the detector 51b.

A stereomicroscope 1c shown in FIG. 5 differs from the stereomicroscope shown in FIG. 3 substantially in that an analysis light beam does not enter an object arrangement 3c as parallel light beam but as an astigmatically shaped light beam. Light emitted from a light source 29c is shaped by a collimation lens 31c to a slightly divergent beam 33c′ and deflected by a deflection mirror 35c into a direction parallel to the optical axis 7c of the objective system 3c. Prior to entering an upper lens group 5c of the objective system 3c, the divergent beam, however, traverses a convex cylinder lens 89 and, as a result, is slightly focused in a y-direction while it is still divergent in an x-direction extending orthogonally thereto. The objective system 3c has a focusing effect both in x-direction and y-direction on the light beam already focused in y-direction so that a light spot 39c generated on an object is substantially circular if the object is positioned in an object plane 13c, i.e., if the object is positioned between an x-focus and a y-focus of the astigmatically shaped beam. If, however, the object is positioned in a plane 41c which is closer to a front lens group 6c than it corresponds to a working distance A of the object plane 13c, a light spot 43c is produced which is elongated in x-direction and thus has a larger diameter in x-direction than in y-direction. Vice versa, a light spot 47c is generated on an object which is positioned in a plane 45c which is disposed remoter from the lens group 6c than it corresponds to the working distance A which is elongated in y-direction and thus has a larger diameter in y-direction than in x-direction.

After deflection at a mirror 55c, an image of the light spots 39c, 43c, 47c is generated on a radiation detector 51c. The radiation detector 51c is provided as a four-quadrant detector with individual detectors I to IV.

The images which the light spots 39c, 43c and 47c produce on the four-quadrant detector 51c are shown in FIGS. 6a, 6b and 6c, respectively.

The image 43c′ of the spot 43c (FIG. 6a) produces in the quadrants II and IV together a larger detector signal than in the quadrants I and III together. The image 39c′ of the spot 39c produces in all quadrants I, II, III and IV about equal signals (FIG. 6b). The image 47c′ of the spot 47c produces in the quadrants II and IV together larger detection signals than in the quadrants I and III together (FIG. 6c). A focusing signal F can thus be determined according to the formula F=(S_{I}+S_{III})−(S_{II}+S_{IV}).

A circuit diagram of a controller for analyzing the shape of the image of the light spot generated by the beam 33c according to this formula is schematically shown in FIG. 7. In this circuit two operation amplifiers are designated by 91 and different resistors are designated by 93. A focusing signal is generated at an output 95 of the circuit which can be utilized as an actuating signal for a drive for adjusting a distance between the two lens groups 5c and 6c.

FIG. 8 shows schematically part of a variant of the embodiment shown in FIG. 5. In this variant, an astigmatic beam 33d is formed in that the light of a light source 29d is shaped to a parallel beam with the aid of a collimation lens 31d. This parallel beam successively passes through a concave cylinder lens 90 and a convex cylinder lens 89d from which the astigmatically shaped analysis light beam 33d then exits and impinges on a deflection mirror 35d positioned on an optical axis 7d so that the astigmatically shaped beam 33d finally enters centrally an upper lens group 5d of an objective system. The deflection mirror 35d is semitransparent so that a four-quadrant detector 51d positioned on the optical axis 7d above the deflection mirror 35d receives a light beam bundle 59d which originates from the object and has been formed by the objective 5d to a parallel beam. This light beam 59d carries the position information for a light spot formed on the object by the astigmatic beam 33d. The evaluation of the signals of the detector 51d can be effected in the same way as described in connection with the embodiment shown in FIG. 5.

FIGS. 9a, 9b and 9c again show different variants of analysis light beam shapes as well as a possible parameterization of the same.

FIG. 9a shows a light spot of elliptic shape, at the top in a stronger defocused state and at the bottom in a less defocused state. A maximal diameter and a minimal diameter b are indicated here as parameters for characterizing the shape. A ratio of b to a is different in the upper Figure than that in the lower Figure.

FIG. 9b shows a four-leaf type shape of the light spot, again at the top in a stronger defocused state than in the lower representation. Again, a maximal diameter a and a minimal diameter b are indicated, and a ratio of the same changes as the defocusing state changes.

FIG. 9c again refers to the example of FIG. 1 with the two light spots 43 and 44 which coincide in a focused state. FIG. 9c is substantially intended to illustrate the correlation to the parameterization with maximal diameter a and minimal diameter b.

In the embodiment according to FIG. 5, the astigmatically shaped analysis light beam is generated in that first a divergent light beam is generated which then traverses a convex cylinder lens and then the focusing lenses of the objective system. As an alternative thereto, it is also possible to first form a parallel beam and to then pass the same successively through a convex cylinder lens and a concave cylinder lens, the main axes of the convex and concave cylinder lenses extending substantially orthogonally to each other. Equally, it is also possible to first form a convergent beam and to pass the same through a concave cylinder lens before it enters the objective system.

In the embodiment shown in FIG. 3, the projection system comprises a pivotable mirror to form the light spot at selected locations in the object plane. Such a pivotable mirror or another device for displacing the light spot in the object plane can also be provided in the embodiments described with reference to FIGS. 1, 2 and 5.

Moreover, it is possible to feed the analysis light beam into the beam path of the objective system also without deflection mirror in that, for example, a downwardly oriented radiation source for forming the analysis light beam is positioned above the upper lens group.

In the embodiments according to FIGS. 3 and 5, an analysis light beam is shown which extends obliquely to the optical axis. However, it is also possible to orient the analysis light beam in these embodiments such that it extends parallel to the optical axis either spaced apart from the optical axis or along the same.

1. A microscopy system for imaging an object, comprising:
a microscopy optics including an objective system (3) with an optical axis (7) and an object plane (13) whose working distance (A) from the objective system (3) is adjustable, and
a first projection system for projecting at least one shaped analysis light beam (33, 34) through the objective system (3) onto the object and for generating at least one light spot (39) on the same,
characterized in that the analysis light beam (33, 34) is shaped such that a shape of a cross-section of the analysis light beam (33, 34) changes in beam direction.

2. The microscopy system according to claim 1, wherein the shape of the cross-section has a maximal diameter (a) and a minimal diameter (b) and wherein a ratio of the minimal diameter (b) to the maximal diameter (a) changes in beam direction.

3. The microscopy system according to claim 1 or 2, wherein the shape of the cross-section of the analysis light beam increasingly elongates with increasing distance from the object plane.

4. The microscopy system according to one of claims 1 to 3, wherein the cross-section of the analysis light beam has a coherent shape in the object plane (13) and has a shape separated into partial components when being spaced apart from the object plane (13).

5. The microscopy system according to one of claims 1 to 4, further comprising:
a position-sensitive radiation detector (51) for supplying data representative of a location-dependency of an intensity of a detected radiation,
an imaging optics for imaging the at least one light spot (39) generated on the object on the position-sensitive radiation detector (51), and
a circuit (61) for evaluating the data and for supplying a focusing signal on the basis of a shape of the at least one light spot (39) imaged on the radiation detector (51) such that the focusing signal is representative of a distance between the object and the object plane.

6. The microscopy system according to claim 5, further comprising a display for displaying the focusing signal for a user.

7. The microscopy system according to claim 5 or 6, further comprising an actuator (9, 11) for adjusting the working distance (A).

8. The microscopy system according to one of claims 5 to 7, wherein the imaging optics comprises the objective system (3).

9. The microscopy system according to one of claims 5 to 8, wherein the first projection system projects two analysis light beams (33, 34) which traverse the objective system spaced apart from each other and overlap in the object plane, and wherein the focusing signal supplied by the controller is representative of a distance of substantially zero when the shape of the imaged light spot is coherent, in particular, with minimal diameter.

10. The microscopy system according to claim 9, wherein the position-sensitive radiation detector is a line detector.

11. The microscopy system according to claim 7 or 8, further comprising a second projection system for projecting an auxiliary light beam (75) of a first wavelength range through the objective system onto the object, the analysis light beam having a second wavelength range which is different from the first wave length range.

12. The microscopy system according to claim 11, wherein a color filter is provided in the imaging optics which is impermeable for the first color.

13. The microscopy system according to one of claims 5 to 8, wherein the first projection system projects an analysis light beam which is substantially focused in the object plane.

14. The microscopy system according to claim 13, wherein the focusing signal supplied by the controller is representative of a distance of substantially zero when the shape of the imaged light spot has a minimal diameter.

15. The microscopy system according to claim 13, wherein the imaging optics comprises a plurality of lenses (81) juxtaposed in the beam cross-section for producing several juxtaposed images of the light spot of different sizes on the radiation detector, and wherein the several lenses have different focal lengths or/and different distances from the radiation detector.

16. The microscopy system according to one of claims 5 to 8, wherein the first projection system projects an astigmatically formed analysis light beam (33c) which is differently convergent in two directions extending orthogonally to each other and to the direction of the analysis light beam.

17. The microscopy system according to claim 16, wherein the position-sensitive radiation detector comprises a four-quadrant photodetector (51c).

18. The microscopy system according to one of claims 5 to 17, wherein the first projection system comprises an intensity-modulated or/and a wavelength-modulated light source for producing the at least one projection light beam.

19. The microscopy system according to one of claims 5 to 18, wherein the projection system comprises an adjustable beam deflector, in particular, a pivotable mirror, for producing the light spot at selectable locations in the object plane.

20. The microscopy system according to one of claims 5 to 19, wherein the projection system comprises a switchable shutter for interrupting the projected analysis light beam.

21. The microscopy system according to one of claims 5 to 20, wherein the two components of the microscopy optics which are displaceable relative to each other are two groups of structural components (5, 6) of the objective system.

22. The microscopy system according to one of claims 5 to 21, wherein the microscopy system is a stereomicroscope, in particular, a surgical microscope.
